(19) United States
(12) Patent Application Publication
(10) Pub. No.: US 2024/0348987 A1
(43) Pub. Date: Oct. 17, 2024

(54) PIEZOELECTRIC VIBRATION DEVICE, SPEAKER UNIT, AND EARPHONE

(71) Applicant: Takahiro EGUCHI, Tokyo (JP)

(72) Inventor: Takahiro EGUCHI, Tokyo (JP)

(73) Assignee: MITSUMI ELECTRIC CO., LTD., Tokyo (JP)

(21) Appl. No.: 18/627,864

(22) Filed: Apr. 5, 2024

(30) Foreign Application Priority Data
Apr. 14, 2023 (JP) 2023-066720

(51) Int. Cl. H04R 17/00; H04R 1/10

(52) U.S. Cl. CPC H04R 17/00; H04R 1/1016; H04R 1/1075; H04R 2201/003; H04R 2400/11

(57) ABSTRACT

A piezoelectric vibration device includes a frame having an elongated shape, a first vibration plate supported by the frame and having an elongated shape elongated in a longitudinal direction of the frame, and a piezoelectric layer arranged on the first vibration plate.

### CROSS-REFERENCE TO RELATED APPLICATIONS

This application claims priority under 35 U.S.C. § 119 to Japanese Patent Application No. 2023-066720, filed Apr. 14, 2023, the contents of which are incorporated herein by reference in their entirety.

### BACKGROUND

### 1. Technical Field

The present disclosure relates to a piezoelectric vibration device, a speaker unit, and an earphone.

### 2. Description of the Related Art

Piezoelectric vibration devices that include a piezoelectric layer and a vibration plate laminated on the piezoelectric layer are used as drivers of speaker units. Patent Document 1 discloses a speaker unit such as a piezoelectric vibration device that includes piezoelectric vibrators, and each of the piezoelectric vibrators has a plate-like vibrating body and a plate-like piezoelectric body that is provided on a surface of the vibrating body. The piezoelectric vibration device includes a vibration transmission part having flexibility and configured to transmit vibration of each piezoelectric vibrator. Patent Document 1 also discloses an earphone including the speaker unit.

Further, compact piezoelectric vibration devices, manufactured by microfabrication techniques or the like developed in micro-electro-mechanical systems (MEMS), have been developed.

### RELATED-ART DOCUMENT

### [Patent Document]

Patent Document 1: Japanese Patent No. 6240821

### SUMMARY

In one aspect of the present disclosure, a piezoelectric vibrating device is provided, the piezoelectric vibrating device including a frame having an elongated shape, a first vibration plate supported by the frame and having an elongated shape elongated in a longitudinal direction of the frame, and a piezoelectric layer arranged on the first vibration plate.

### BRIEF DESCRIPTION OF THE DRAWINGS

FIG. 1 is a perspective view of a piezoelectric vibration device according to a first embodiment.

FIG. 2 is a perspective view of the piezoelectric vibration device according to the first embodiment, as viewed from another angle.

FIG. 3 is a perspective view of the piezoelectric vibration device according to a first modification of the first embodiment.

FIG. 4 is a perspective view of the piezoelectric vibration device in the first modification of the first embodiment, as viewed from another angle.

FIG. 5 is a perspective view of the piezoelectric vibration device according to a second modification of the first embodiment.

FIG. 6 is a cross-sectional view illustrating another configuration example of the piezoelectric vibration device according to the second modification of the first embodiment.

FIG. 7 is a perspective view of a speaker unit according to a second embodiment.

FIG. 8 is a perspective view of the speaker unit according to the second embodiment, as viewed from the front side.

FIG. 9 is a perspective view of the speaker unit according to the second embodiment, as viewed from the rear side.

FIG. 10 is a schematic view illustrating a state of use of an earphone according to a third embodiment.

### DETAILED DESCRIPTION

The inventor of this application has recognized the following information relating to the related art. An area of a piezoelectric layer is reduced by making a piezoelectric vibration device compact. In this arrangement, it is assumed that sound pressure in a low range is specially reduced.

An earphone disclosed in Patent Document 1 is worn outside an external auditory canal of an ear. That is, the earphone disclosed in Patent Document 1 is disposed at a position away from an eardrum of a user. With this arrangement, in a case where a compact piezoelectric vibration device is provided as in the earphone disclosed in Patent Document 1, there is a possibility that a sound wave in the low range having sufficient sound pressure cannot be transmitted to the eardrum.

In view of the situation recognized by the inventor, an object of the present disclosure is to provide a piezoelectric vibration device, a speaker unit, and an earphone that are compact and have increased sound pressure in a low range.

Hereinafter, embodiments of the present disclosure will be described with reference to the drawings. In the drawings, the same members may be denoted by the same reference numerals. In the description of the drawings, the same components as those described earlier may not be described.

In each drawing, orthogonal coordinates having an X axis, a Y axis, and a Z axis are used as direction expressions. The X axis, the Y axis, and the Z axis are orthogonal to each other. An X direction along the X axis indicates a width direction of a piezoelectric vibration device according to the embodiments. A Y direction along the Y axis indicates a depth direction of the piezoelectric vibration device according to the embodiments. A Z direction along the Z axis indicates a thickness direction of the piezoelectric vibration device according to the embodiments. In each of the X direction, the Y direction, and the Z direction, a side to which an arrow is directed is referred to as a “+ side,” and an opposite side thereof is referred to as a “− side.” The X direction and the Y direction may be referred to as “in-plane directions.” The Z direction may be referred to as a “direction perpendicular to a plane.” However, these do not limit the orientation of the piezoelectric vibration device according to the embodiments during use, and the orientation of the piezoelectric vibration device according to the embodiment is arbitrary.

### First Embodiment

### <Piezoelectric Vibration Device>

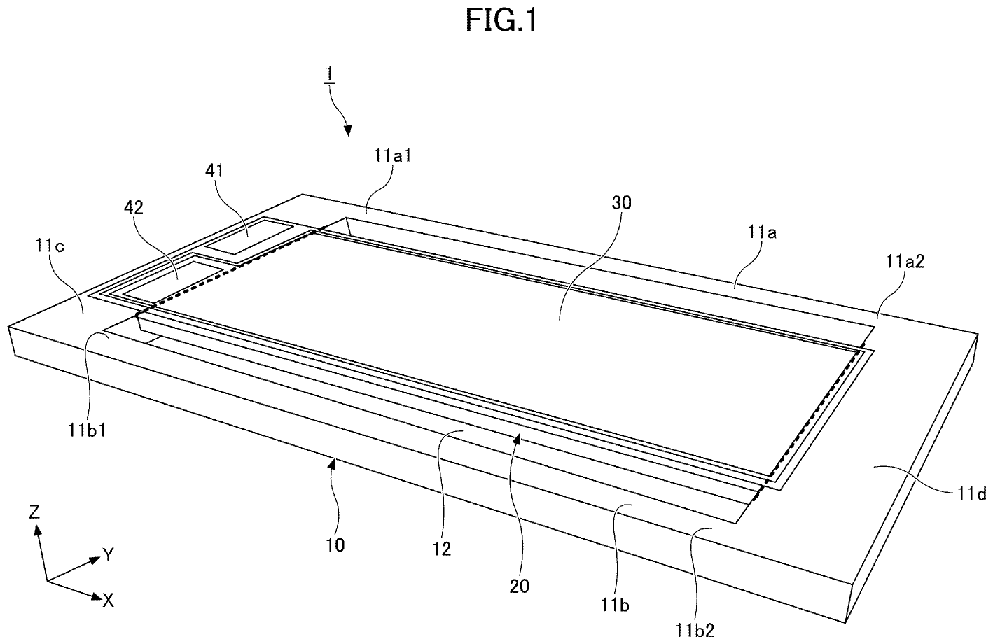

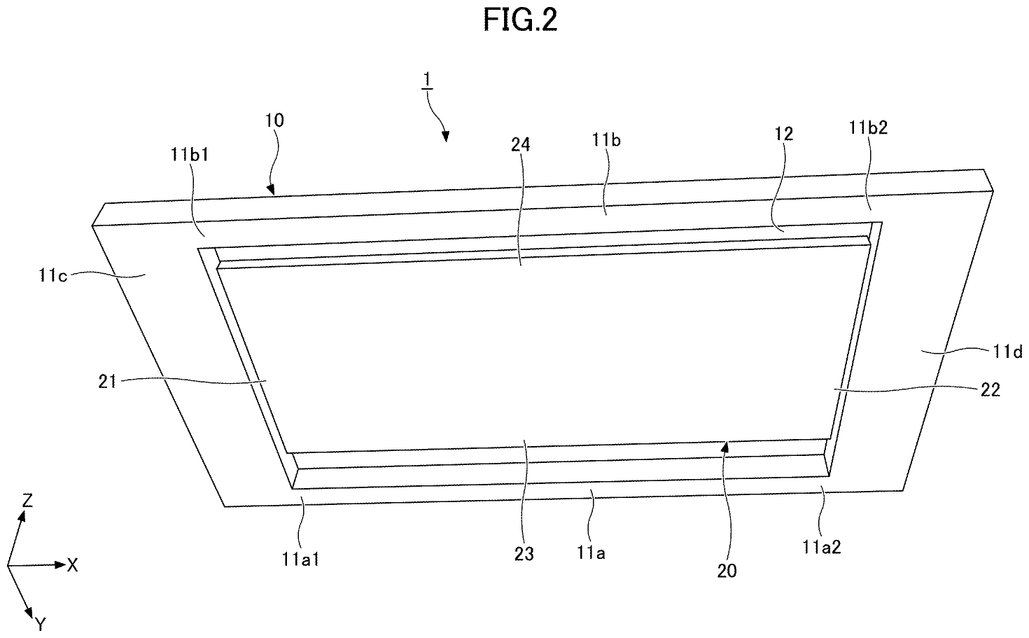

An example of an overall configuration of a piezoelectric vibration device 1 according to a first embodiment of the present disclosure will be described with reference to FIG. 1 and FIG. 2. FIG. 1 is a perspective view of the piezoelectric vibration device 1 according to the first embodiment as viewed from the + side in the Z direction. FIG. 2 is a perspective view of the piezoelectric vibration device 1 according to the first embodiment as viewed from the − side in the Z direction.

As illustrated in FIG. 1 and FIG. 2, the piezoelectric vibration device 1 includes a frame 10, a vibration plate 20, a piezoelectric layer 30, a first electrode pad 41, and a second electrode pad 42. The piezoelectric vibration device 1 of this embodiment has an elongated shape in which the length in the X direction is longer than the length in the Y direction. In this embodiment, the longitudinal direction of the piezoelectric vibration device 1 corresponds to the X direction. The widthwise direction of the piezoelectric vibration device 1 corresponds to the Y direction. However, the longitudinal direction of the piezoelectric vibration device 1 is not limited to the X direction, and may be another direction such as the Y direction.

The frame 10 is an elongated member serving as a base of the piezoelectric vibration device 1. In the present embodiment, the length of the frame 10 along the X direction is longer than that along the Y direction. The longitudinal direction of the frame 10 corresponds to the X direction. The widthwise direction of the frame 10 corresponds to the Y direction. However, the longitudinal direction of the frame 10 is not limited to the X direction, and may be another direction such as the Y direction.

The frame 10 has a frame shape as illustrated in FIG. 1 and FIG. 2. The frame 10 includes a first long side portion 11a, a second long side portion 11b, a first short side portion 11c, and a second short side portion 11d. An opening 12 penetrating through the frame 10 in the direction perpendicular to the plane of the frame 10 is formed in a region surrounded by the first long side portion 11a, the second long side portion 11b, the first short side portion 11c, and the second short side portion 11d. The first long side portion 11a and the second long side portion 11b are examples of the “long side portion” of the piezoelectric vibration device 1. The first short side portion 11c and the second short side portion 11d are examples of the “short side portion” of the piezoelectric vibration device 1.

Each of the first long side portion 11a and the second long side portion 11b of this embodiment extends along the X direction. Each of the first long side portion 11a and the second long side portion 11b has a band shape. The first long side portion 11a and the second long side portion 11b have substantially the same length. The first long side portion 11a and the second long side portion 11b are preferably parallel to each other. However, the forms of the first long side portion 11a and the second long side portion 11b and the positional relationship between the first long side portion 11a and the second long side portion 11b are not limited to these.

Each of the first short side portion 11c and the second short side portion 11d of this embodiment extends along the Y direction. Each of the first short side portion 11c and the second short side portion 11d has a band shape. The first short side portion 11c and the second short side portion 11d have substantially the same length. The first short side portion 11c and the second short side portion 11d are preferably parallel to each other. However, the forms of the first short side portion 11c and the second short side portion 11d and the positional relationship between the first short side portion 11c and the second short side portion 11d are not limited to these.

The first short side portion 11c connects one end 11al located on the − side in the X direction of the first long side portion 11a and one end 11b1 located on the − side in the X direction of the second long side portion 11b. The second short side portion 11d connects other end 11a2 located on the + side in the X direction of the first long side portion 11a and other end 11b2 located on the + side in the X direction of the second long side portion 11b.

The first long side portion 11a intersects with each of the first short side portion 11c and the second short side portion 11d at substantially right angles. The second long side portion 11b also intersects with each of the first short side portion 11c and the second short side portion 11d at substantially right angles. That is, the frame 10 has a rectangular planar shape. Similarly, the opening 12 has a rectangular planar shape. The planar shapes of the frame 10 and the opening 12 are, however, not limited thereto, and may be other shapes such as an ellipse and a parallelogram.

The first long side portion 11a and the second long side portion 11b preferably have lengths that are, for example, between three times and ten times, inclusive, the lengths of the first short side portion 11c and the second short side portion 11d. However, the lengths of the first long side portion 11a and the second long side portion 11b are not limited thereto.

The frame 10 may be obtained by processing a semiconductor substrate or an insulator substrate such as a silicon (Si) substrate or a silicon on insulator (SOI) substrate. The frame 10 may be integrated with the vibration plate 20 or may be separated from the vibration plate 20. In a case where the frame 10 and the vibration plate 20 are integrated, the vibration plate 20 extending between the first short side portion 11c and the second short side portion 11d of the frame 10 may be formed by removing a predetermined portion of the frame 10 before processing using a process such as wet etching or dry etching.

The frame 10 may include, for example, a drive circuit for driving the piezoelectric layer 30. The drive circuit may be formed inside the frame 10, or on the lower surface of at least one of the first long side portion 11a, the second long side portion 11b, the first short side portion 11c, or the second short side portion 11d of the frame 10.

The vibration plate 20 is an elongated plate material having flexibility. The vibration plate 20 has a rectangular planar shape. The vibration plate 20 vibrates in response to the vibration of the piezoelectric layer 30. When the vibration plate 20 vibrates, the piezoelectric vibration device 1 emits a sound wave in a range corresponding to the vibration frequency. The vibration plate 20 is an example of a “first vibration plate.”

The longitudinal direction of the vibration plate 20 is parallel to the longitudinal direction of the frame 10. That is, the vibration plate 20 extends along the longitudinal direction of the frame 10. The widthwise direction of the vibration plate 20 is parallel to the widthwise direction of the frame 10. In this embodiment, the length of the vibration plate 20 in the X direction is longer than the length in the Y direction. The longitudinal direction of the vibration plate 20 corresponds to the X direction. The widthwise direction of the vibration plate 20 corresponds to the Y direction.

The vibration plate 20 is disposed so as to overlap at least a part of the opening 12 of the frame 10. That is, the lower surface of the vibration plate 20 faces the opening 12. With this arrangement, the vibration plate 20 can freely vibrate in the direction perpendicular to the plane of the vibration plate 20.

The vibration plate 20 of this embodiment is supported by the frame 10 having what is known as a both ends supported beam structure. Specifically, as illustrated in FIG. 2, a first short edge 21 of the vibration plate 20 is continuous with the first short side portion 11c of the frame 10. Thus, the first short edge 21 of the vibration plate 20 is supported by the first short side portion 11c. A second short edge 22 of the vibration plate 20 is continuous with the second short side portion 11d of the frame 10. Thus, the second short edge 22 of the vibration plate 20 is supported by the second short side portion 11d.

A first long edge 23 of the vibration plate 20 faces the first long side portion 11a of the frame 10 with a clearance therebetween. That is, the first long side portion 11a of the frame 10 and the first long edge 23 of the vibration plate 20 are disposed to be separated from each other. A second long edge 24 of the vibration plate 20 faces the second long side portion 11b of the frame 10 with a clearance therebetween. That is, the second long side portion 11b of the frame 10 and the second long edge 24 of the vibration plate 20 are disposed to be separated from each other.

With this arrangement, the vibration plate 20 is supported by the frame 10 having the both ends supported beam structure, and thus the first long edge 23 and the second long edge 24 of the vibration plate 20 are not restrained by the frame 10 when the vibration plate 20 vibrates. As a result, the amplitude of the vibration plate 20 can be increased, and the sound pressure of the sound wave emitted from the vibration plate 20 can be increased.

The vibration plate 20 of this embodiment is made of Si. However, the material of the vibration plate 20 is not limited thereto. Other materials for the vibration plate 20 include semiconductors such as gallium arsenide (GaAs), dielectrics such as silica dioxide (SiO₂), sapphire, alumina, and silica, metals such as aluminum and titanium, resins such as polyimide (PI), epoxy, polyether ether ketone (PEEK), polyethylene naphthalate (PEN), polyethylene terephthalate (PET), polyphenylene sulfide (PPS), and polyolefin, and rubbers.

The piezoelectric layer 30 is a layer configured to include a piezoelectric material that converts applied electrical energy into mechanical energy. The piezoelectric layer 30 functions as a vibration source of the piezoelectric vibration device 1. The piezoelectric layer 30 resonates and vibrates in the direction perpendicular to the plane of the piezoelectric layer 30 in response to input of the AC signal.

Examples of the piezoelectric layer 30 include a piezoelectric thin film containing zinc oxide (ZnO), aluminum nitride (AlN), lead zirconate titanate (PZT), or the like. In a case where the piezoelectric layer 30 is an AlN film, the AlN film may or may not contain impurities. Examples of the impurity contained in the AlN film include rare-earth metal elements such as scandium (Sc), erbium (Er), yttrium (Y), and lanthanum (La), transition metal elements such as hafnium (Hf), Ti, Ta, and Nb, and alkaline-earth metal elements such as Mg.

The piezoelectric layer 30 is disposed on the vibration plate 20. The piezoelectric layer 30 is preferably formed on substantially the entire upper surface of the vibration plate 20. The piezoelectric layer 30 is formed on substantially the entire upper surface of the vibration plate 20, and thus the elongated piezoelectric layer 30 can be formed. In such a case, the length of the piezoelectric layer 30 in the X direction is longer than the length in the Y direction. The longitudinal direction of the piezoelectric layer 30 corresponds to the X direction. The widthwise direction of the piezoelectric layer 30 corresponds to the Y direction.

Each of the piezoelectric layer 30 and the vibration plate 20 has an elongated shape. That is, the piezoelectric layer 30 and the vibration plate 20 have a long length in a direction (in-plane direction) perpendicular to the vibrating direction. Thus, a sound wave on the long wavelength side having a sufficient amplitude can be propagated through both the piezoelectric layer 30 and the vibration plate 20. As a result, the sound pressure in the low range generated from the piezoelectric vibration device 1 can be increased.

The piezoelectric layer 30 may be what is known as a unimorph piezoelectric layer formed of a single-layer piezoelectric film. The piezoelectric layer 30 may be what is known as a bimorph piezoelectric layer formed of two different piezoelectric films.

The first electrode pad 41 is an electrode for inputting an AC signal corresponding to the resonance frequency of the piezoelectric layer 30. As illustrated in FIG. 1, the first electrode pad 41 is disposed on the piezoelectric layer 30.

As illustrated in FIG. 1, the second electrode pad 42 is disposed at a position different from the first electrode pad 41 on the piezoelectric layer 30. The second electrode pad 42 of this embodiment is electrically connected to, for example, the ground. Examples of the first electrode pad 41 and the second electrode pad 42 include gold (Au), molybdenum (Mo), ruthenium (Ru), iridium (Ir), aluminum (Al), platinum (Pt), titanium (Ti), tungsten (W), palladium (Pd), tantalum (Ta), chromium (Cr), nickel (Ni), niobium (Nb), alloys of any of these metals, compounds of any of these metals, or laminated films obtained by appropriately laminating any of these metals, alloys, and compounds. However, the first electrode pad 41 and the second electrode pad 42 are not limited to these.

The first electrode pad 41 and the second electrode pad 42 of this embodiment are arranged side by side on the same end portion side of the piezoelectric layer 30. The first electrode pad 41 and the second electrode pad 42 are arranged side by side on the same end portion side of the piezoelectric layer 30, and thus it is possible to draw out the wiring to be connected to each of the first electrode pad 41 and the second electrode pad 42 from the same end portion of the piezoelectric vibration device 1. Thus, it is possible to achieve saving of space for the piezoelectric vibration device 1. As a result, the piezoelectric vibration device 1 can be further downsized.

### First Modification of First Embodiment

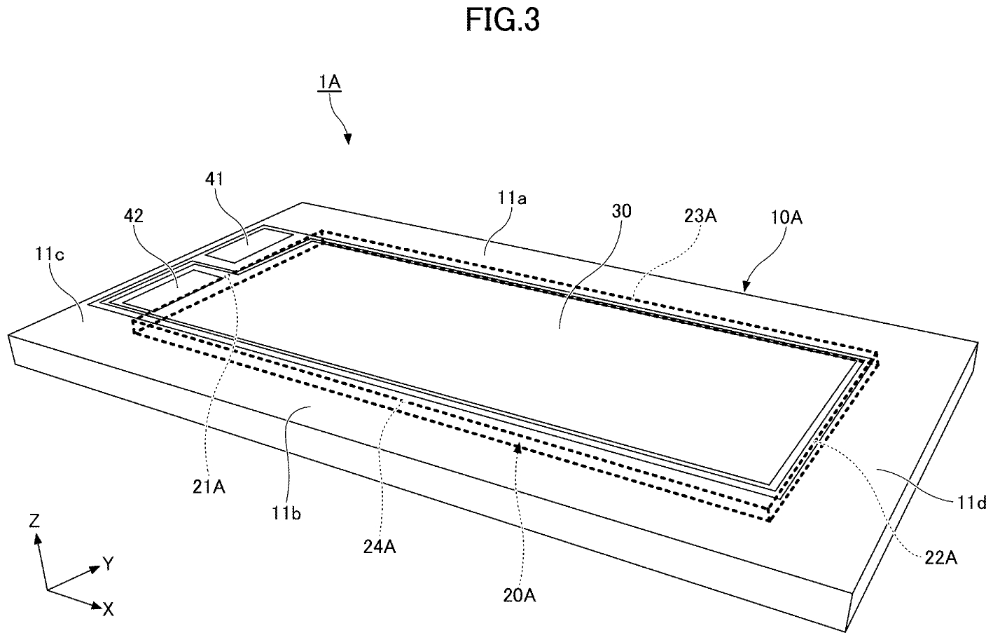

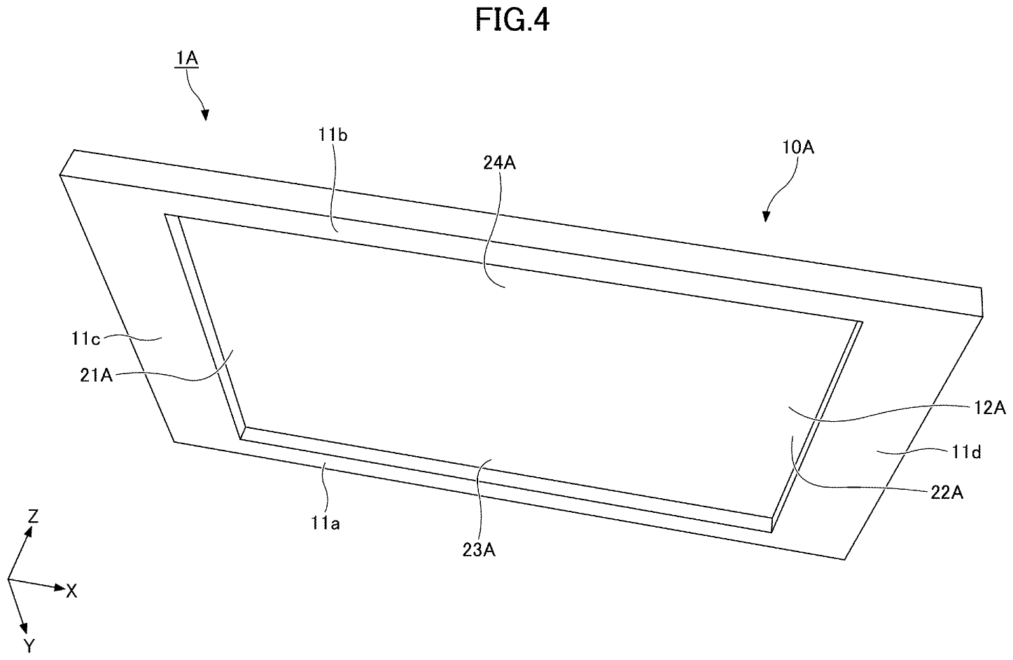

A piezoelectric vibration device 1A according to a first modification of the first embodiment will now be described with reference to FIG. 3 and FIG. 4. FIG. 3 is a perspective view of the piezoelectric vibration device 1A in the first modification of the first embodiment, as viewed from the + side in the Z direction. FIG. 4 is a perspective view of the piezoelectric vibration device 1A in the first modification of the first embodiment, as viewed from the − side in the Z direction. In the first modification, the description of the same components as those of the first embodiment will be appropriately omitted.

A vibration plate 20A in the first modification is supported by a frame 10A in a diaphragm form. Specifically, each of the four edges of the vibration plate 20A is continuous with different portions of the frame 10A. That is, as illustrated in FIG. 3 and FIG. 4, a first short edge 21A of the vibration plate 20A is continuous with the first short side portion 11c of the frame 10A. A second short edge 22A of the vibration plate 20A is continuous with the second short side portion 11d of the frame 10A. A first long edge 23A of the vibration plate 20A is continuous with the first long side portion 11a of the frame 10A. A second long edge 24A of the vibration plate 20A is continuous with the second long side portion 11b of the frame 10A. Thus, the frame 10A and the vibration plate 20A are integrally connected without a clearance. The vibration plate 20A is an example of a “first vibration plate.” In the frame 10A, a hollow region 12A having a

recessed shape is formed, which is surrounded by the first long side portion 11a, the second long side portion 11b, the first short side portion 11c, and the second short side portion 11d (see FIG. 4). The vibration plate 20A covers the hollow region 12A. The lower surface of the vibration plate 20A faces the hollow region 12A. Thus, the vibration plate 20A faces the hollow region 12A and is supported by the frame 10A in a film-like manner, and can freely vibrate in the direction perpendicular to the surface of the vibration plate 20A. The first long side portion 11a and the second long side portion 11b are examples of the “long side portion” of the piezoelectric vibration device 1A. The first short side portion 11c and the second short side portion 11d are examples of the “short side portion” of the piezoelectric vibration device 1A.

In the first modification, it is preferable that the piezoelectric layer 30 is formed on substantially the entire upper surface of the vibration plate 20A. That is, in the first modification, the elongated vibration plate 20A and the piezoelectric layer 30 both extending in the longitudinal direction of the frame 10A are provided. Thus, a sound wave on the long wavelength side having a sufficient amplitude can be propagated through both the vibration plate 20A and the piezoelectric layer 30. As a result, the sound pressure in the low range generated from the piezoelectric vibration device 1A can be increased.

### Second Modification of First Embodiment

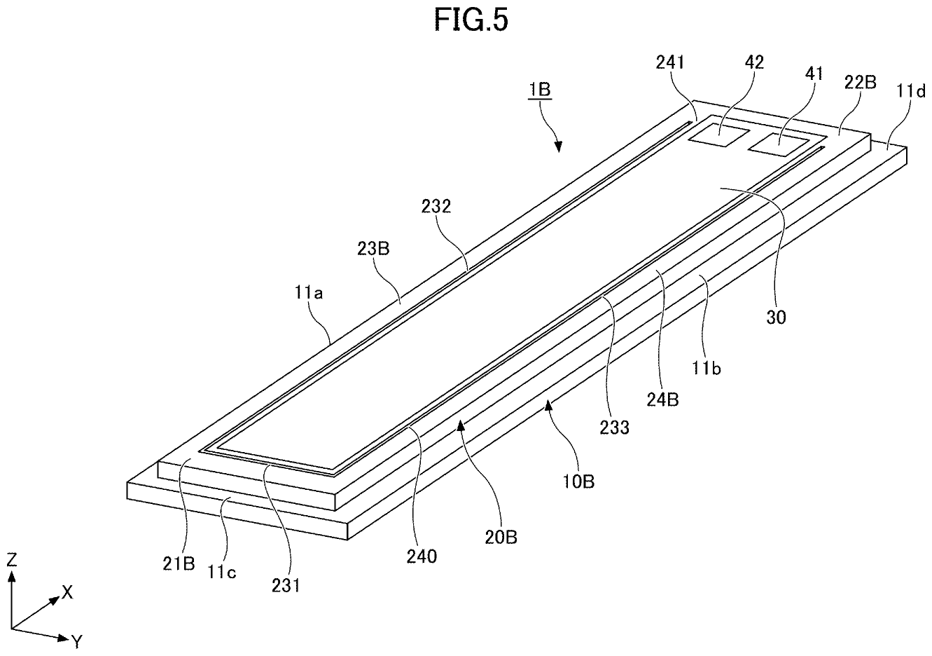

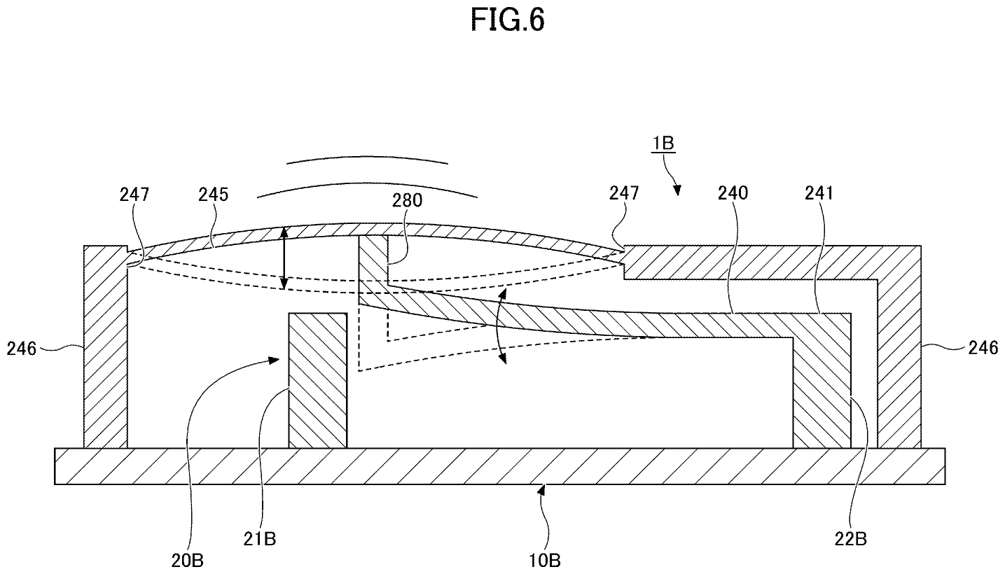

A piezoelectric vibration device 1B according to a second modification of the first embodiment will be described with reference to FIG. 5 and FIG. 6. FIG. 5 is a perspective view of the piezoelectric vibration device 1B according to the second modification of the first embodiment, as viewed from the + side in the Z direction. FIG. 6 is a cross-sectional view illustrating another configuration example of the piezoelectric vibration device 1B according to the second modification of the first embodiment. In the second modification, the description of the same components as those of the first embodiment and the first modification will be appropriately omitted.

A vibration plate 20B according to the second modification is supported by a frame 10B having a cantilever structure. The structure of the frame 10B and the structure of the vibration plate 20B are not limited as long as the vibration plate 20B is supported by the frame 10B in the cantilever manner. Examples of the frame 10B and the vibration plate 20B include the following described below. The vibration plate 20B is an example of the “first vibration plate.”

The frame 10B includes the first long side portion 11a, the second long side portion 11b, the first short side portion 11c, and the second short side portion 11d. Further, a hollow region surrounded by the first long side portion 11a, the second long side portion 11b, the first short side portion 11c, and the second short side portion 11d is formed. Although the hollow region is not illustrated in FIG. 5, the hollow region is formed in a region of the frame 10B covered with the vibration plate 20B. The first long side portion 11a and the second long side portion 11b are examples of the “long side portion” of the piezoelectric vibration device 1B. The first short side portion 11c and the second short side portion 11d are examples of the “short side portion” of the piezoelectric vibration device 1B.

The vibration plate 20B is arranged on the frame 10B, as illustrated in FIG. 5. The vibration plate 20B is provided with a first slit 231, a second slit 232, and a third slit 233, which are linear slits extending in respective predetermined directions in the plane of the vibration plate 20B. Each of the first slit 231, the second slit 232, and the third slit 233 penetrates the vibration plate 20B in the direction perpendicular to the plane of the vibration plate 20B.

The first slit 231 is adjacent to a first short edge 21B of the vibration plate 20B and extends in parallel to the first short edge 21B. The second slit 232 is adjacent to a first long edge 23B of the vibration plate 20B and extends in parallel to the first long edge 23B. The third slit 233 is adjacent to a second long edge 24B of the vibration plate 20B and extends in parallel to the second long edge 24B.

The second slit 232 and the third slit 233 are parallel to each other and have substantially the same length. The first slit 231 connects one end of the second slit 232 and one end of the third slit 233 (end portions of the vibration plate 20B on the side close to the first short edge 21B). Thus, a series of through paths is formed with the first slit 231, the second slit 232, and the third slit 233. As a result, a vibration region 240 having the cantilever structure surrounded by the first slit 231, the second slit 232, and the third slit 233 is formed.

In the vibration plate 20B, a slit parallel to a second short edge 22B is not formed in the vicinity of the second short edge 22B. Therefore, in the vibration region 240, the second short edge 22B side of the vibration plate 20B corresponds to a fixed end 241. That is, the region of the fixed end 241 in the vibration plate 20B is supported by the second short side portion 11d of the frame 10B. In the vibration region 240, a portion extending from the fixed end 241 to the first short edge 21B side is not restricted by other members and can freely vibrate. The first electrode pad 41 and the second electrode pad 42 are arranged on the fixed end 241 side.

In the second modification, the piezoelectric layer 30 is preferably formed on substantially the entire surface of the vibration region 240. That is, also in the second modification, the elongated vibration plate 20B and the piezoelectric layer 30 extending in the longitudinal direction of the frame 10B are provided. Thus, a sound wave on the long wavelength side having a sufficient amplitude can be propagated through both the vibration plate 20B and the piezoelectric layer 30. As a result, the sound pressure in the low range generated from the piezoelectric vibration device 1B can be increased. The vibration plate 20B is supported by the frame 10B in the cantilever manner. Therefore, the amount of shift of the vibration plate 20B during vibration can be increased compared to a case where the vibration plate 20B is supported by the frame 10B by another structure. As a result, the sound pressure in the low range propagating from the piezoelectric vibration device 1 can be further increased.

Further, as illustrated in FIG. 6, the piezoelectric vibration device 1B may include a membrane 245 connected to the vibration region 240 of the vibration plate 20B. The membrane 245 is a flexible film (plate)-shaped member and vibrates in conjunction with the vibration of the vibration region 240. As illustrated in FIG. 6, the membrane 245 may be connected to the vibration region 240 through a connecting body 280. The connecting body 280 illustrated in FIG. 6 is a rod-shaped member, but is not limited to the above example. The membrane 245 is an example of a “second vibration plate.”

In a case where only the vibration region 240 of the vibration plate 20B is vibrated, the first slit 231, the second slit 232, and the third slit 233 may be escape routes for the air pushed out due to the vibration of the vibration region 240, depending on the lengths and widths of the first slit 231, the second slit 232, and the third slit 233. In such a way, in a case where the air pushed out due to the vibration of the vibration region 240 escapes through the first slit 231, the second slit 232, and the third slit 233, there is a concern that a sound wave having sufficient sound pressure (sound volume) may not be obtained. However, by separately providing the membrane 245 that vibrates in conjunction with the vibration region 240, it is possible to obtain a sound wave having sufficient sound pressure through the vibration of the membrane 245.

The support structure of the membrane 245 included in the piezoelectric vibration device 1B is not particularly limited, but for example, a structure in which a housing 246 covering at least the upper side of the vibration plate 20B is further provided, and the membrane 245 is supported by an edge 247 of an opening formed on, for example, the upper surface of the housing 246 may be exemplified.

The structure of the second vibration plate such as the membrane 245 is not limited. The second vibration plate such as the membrane 245 may be provided in the piezoelectric vibration device 1 according to the first embodiment and the piezoelectric vibration device 1A in the first modification.

### Second Embodiment

### <Speaker Unit>

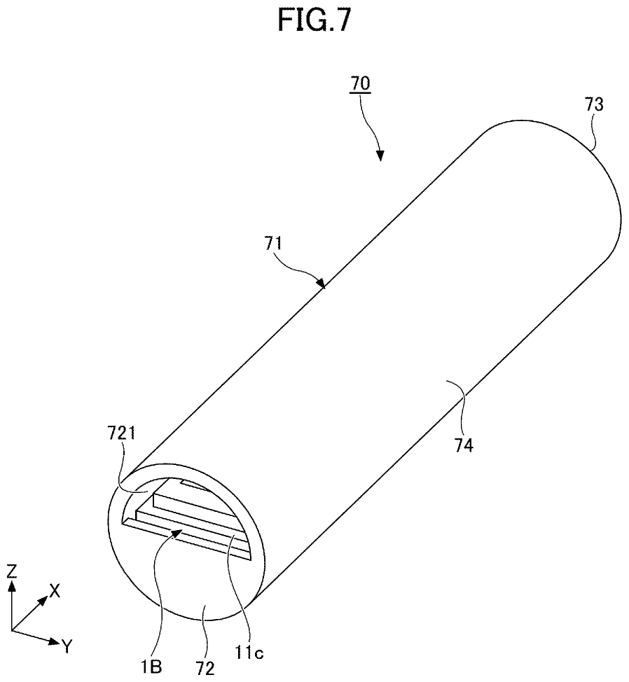

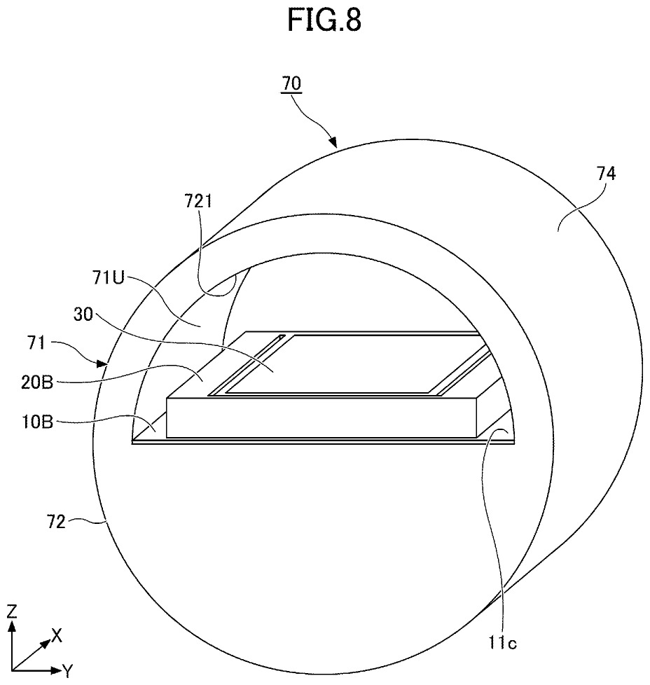

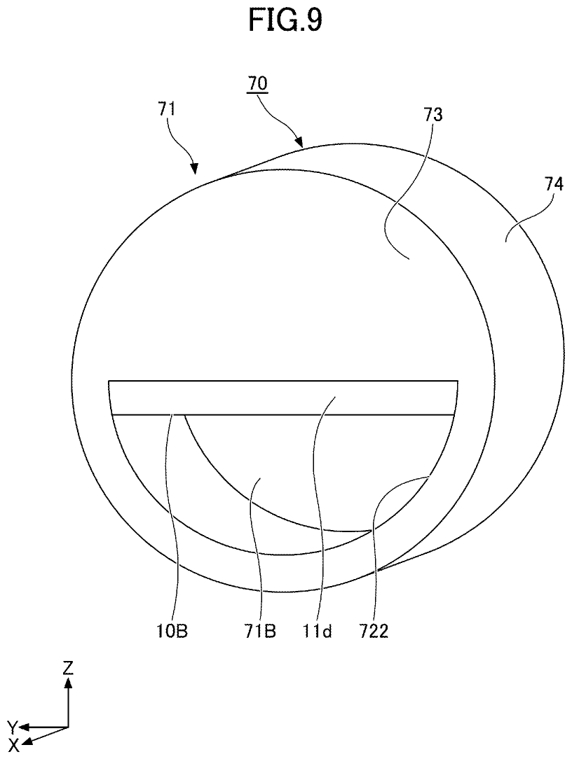

Hereinafter, a configuration example of a speaker unit 70 according to a second embodiment of the present disclosure will be described with reference to FIG. 7 to FIG. 9. FIG. 7 is a perspective view of the speaker unit 70 according to the second embodiment of the present disclosure, as viewed from the + side in the Z direction. FIG. 8 is a perspective view of the speaker unit 70 as viewed from the front side. FIG. 9 is a perspective view of the speaker unit 70 as viewed from the rear side. In the second embodiment, the description of the same components as those of the first embodiment and the modifications of the first embodiment will be appropriately omitted.

As illustrated in FIG. 7, the speaker unit 70 includes the piezoelectric vibration device 1B and a housing 71 that houses the piezoelectric vibration device 1B. The piezoelectric vibration device accommodated in the housing 71 is not limited to the piezoelectric vibration device 1B according to the second modification of the first embodiment. That is, the piezoelectric vibration device 1 according to the first embodiment or the piezoelectric vibration device 1A in the first modification may be accommodated in the housing 71.

The housing 71 has an elongated cylindrical shape. The inside of the housing 71 is hollow. Specifically, the housing 71 includes a front wall 72, a rear wall 73, and a side peripheral wall 74 connecting the front wall 72 and the rear wall 73. The front wall 72 is an example of a “first wall,” and the rear wall 73 is an example of a “second wall.”

In this embodiment, the length of the housing 71 in the X direction is longer than the length in the Y direction. The longitudinal direction of the housing 71 corresponds to the X direction. The widthwise direction of the housing 71 corresponds to the Y direction. However, the longitudinal direction of the housing 71 is not limited to the X direction, and may be another direction such as the Y direction.

When the piezoelectric vibration device 1B is accommodated in the housing 71, both ends of the piezoelectric vibration device 1B are supported by the front wall 72 and the rear wall 73 of the housing 71, respectively. In this embodiment, as illustrated in FIG. 8, the first short side portion 11c of the frame 10B is supported by the front wall 72 of the housing 71. As illustrated in FIG. 9, the second short side portion 11d of the frame 10B is supported by the rear wall 73 of the housing 71. Thus, the piezoelectric vibration device 1B is accommodated in the housing 71 in a horizontal state.

As illustrated in FIG. 8 and FIG. 9, an upper space 71U and a lower space 71B separated by the piezoelectric vibration device 1B are formed in the housing 71. The vibration plate 20B and the piezoelectric layer 30 are disposed on the upper space 71U side. The frame 10B is disposed on the lower space 71B side. The upper space 71U is an example of a “first space,” and the lower space 71B is an example of a “second space.”

As illustrated in FIG. 8, a semicircular first opening 721 is provided on the upper side of the front wall 72. The upper space 71U communicates with the outside of the housing 71 through the first opening 721. Among the sound waves generated by the vibration of the vibration plate 20B, the sound waves propagating upward from the vibration plate 20B pass through the first opening 721 to propagate to the outside of the housing 71. The shape of the first opening 721 is not limited to a semicircle. The shape of the first opening 721 may be, for example, a circle, an ellipse, a circular sector, a polygon such as a triangle, or the like.

As illustrated in FIG. 9, a semicircular second opening 722 is provided on the lower side of the rear wall 73. The lower space 71B communicates with the outside of the housing 71 through the second opening 722. Among the sound waves generated by the vibration of the vibration plate 20B, the sound waves propagating downward from the vibration plate 20B pass through the hollow region of the frame 10B. The sound wave that has passed through the hollow region of the frame 10B passes through the second opening 722 to propagate to the outside of the housing 71.

In a case where the second opening 722 is not provided in the housing 71, the sound wave propagating upward from the vibration plate 20B and the sound wave propagating downward from the vibration plate 20B cancel each other out in the housing 71. As a result, a situation may occur in which a sound wave having sufficient sound pressure is not propagated to the outside of the housing 71. However, by providing the second opening 722 in the housing 71, a passage is formed through which the sound wave propagating downward from the vibration plate 20B escapes to the outside of the housing 71. Thus, it is possible to prevent a situation in which the sound wave propagating upward from the vibration plate 20B and the sound wave propagating downward from the vibration plate 20B cancel each other out in the housing 71. As a result, a sound wave having sufficient sound pressure can be propagated to the outside of the housing 71.

The shape of the second opening 722 is not limited to a semicircle. The shape of the second opening 722 may be, for example, a circle, an ellipse, a circular sector, a polygon such as a triangle, or the like.

### Third Embodiment

### <Earphone>

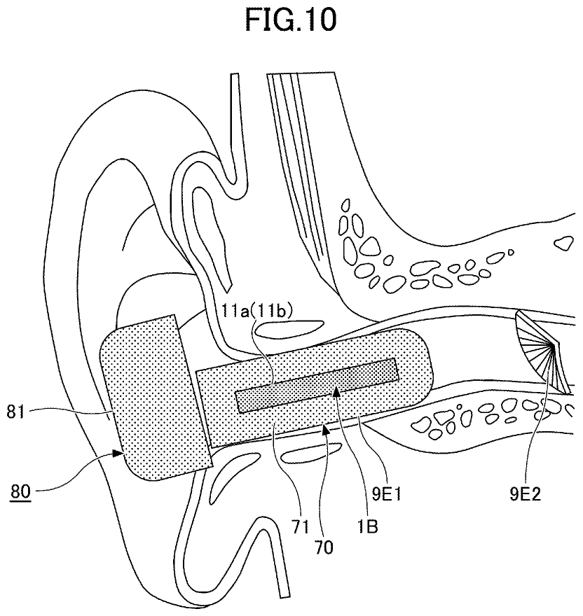

Hereinafter, a configuration example of an earphone 80 according to a third embodiment of the present disclosure will be described with reference to FIG. 10. FIG. 10 is a schematic view illustrating a state of use of the earphone 80 according to the third embodiment of the present disclosure. In the third embodiment, the description of the same components as those of the first embodiment, the modifications of the first embodiment, and the second embodiment will be appropriately omitted.

As illustrated in FIG. 10, the earphone 80 includes the speaker unit 70 according to the second embodiment and a knob portion 81 connected to the speaker unit 70. The speaker unit 70 is disposed on the tip end side of the earphone 80. As illustrated in FIG. 10, the speaker unit 70 has an elongated shape, and thus can be inserted into a part of the user's ear that is an external auditory canal 9E1. That is, the piezoelectric vibration device 1B can be arranged inside the external auditory canal 9E1 by arranging the piezoelectric vibration device 1B, which is a sound source, such that the longitudinal direction of the first long side portion 11a, the second long side portion 11b, and the housing 71 is directed in the depth direction of the external auditory canal toward an eardrum 9E2. This allows the piezoelectric vibration device 1B to be disposed at a position close to the user's eardrum 9E2, and allows sound waves in the low range having sufficient sound pressure to be transmitted to the eardrum. The same effects are also obtained in the cases where the piezoelectric vibration device 1 according to the first embodiment and the piezoelectric vibration device 1A in the first modification of the first embodiment are used.

The preferred embodiments and the like have been described in detail above. However, the present disclosure is not limited to the above-described embodiments. For example, various modifications and substitutions can be made to the above-described embodiments without departing from the scope set forth in the present disclosure.

The present disclosure relates to, for example, the following aspects:

<1> A piezoelectric vibration device includes
a frame having an elongated shape,
a first vibration plate supported by the frame and having an elongated shape elongated in a longitudinal direction of the frame, and
a piezoelectric layer arranged on the first vibration plate.

<2> In a piezoelectric vibration device in <1> above, a frame includes
a first long side portion,
a second long side portion opposite the first long side portion,
a first short side portion connecting a first end of the first long side portion and a first end of the second long side portion, and
a second short side portion facing the first short side portion and connecting a second end of the first long side portion and a second end of the second long side portion,
where the first vibration plate is supported by at least one of the first short side portion or the second short side portion.

<3> A piezoelectric vibration device in <1> or <2> above further includes a second vibration plate connected to a first vibration plate through a connecting body and configured to vibrate in conjunction with vibration of the first vibration plate.

<4> A speaker unit includes a piezoelectric vibration device including
a frame having an elongated shape,
a first vibration plate supported by the frame and having an elongated shape elongated in a longitudinal direction of the frame, and
a piezoelectric layer arranged on the first vibration plate.

<5> A speaker unit in <4> above further includes
a housing having an elongated cylindrical shape and accommodating the piezoelectric vibration device, where
the housing has a first opening and a second opening,
the housing includes a first space and a second space that are separated by the piezoelectric vibration device,
the first opening communicates with the first space, and
the second opening communicates with the second space.

<6> An earphone includes a speaker unit including
a piezoelectric vibration device, the piezoelectric vibration device including
a frame having an elongated shape,
a first vibration plate supported by the frame and having an elongated shape elongated in a longitudinal direction of the frame, and
a piezoelectric layer arranged on the first vibration plate.

<7> In an earphone in <6> above, a speaker unit includes a housing having an elongated cylindrical shape and accommodating the piezoelectric vibration device, where
the housing has a first opening and a second opening,
the housing includes a first space and a second space that are separated by the piezoelectric vibration device,
the first opening communicates with the first space, and
the second opening communicates with the second space.

<8> In an earphone in <6> or <7> above, a speaker unit includes a housing having an elongated cylindrical shape and accommodating the piezoelectric vibration device, and
a long side portion of the piezoelectric vibration device or a longitudinal direction of the housing is directed in a depth direction of an external auditory canal of an ear of a user.

In the present disclosure, a piezoelectric vibration device, a speaker unit, and an earphone that are compact and have increased sound pressure in a low range can be provided.

What is claimed is:

1. A piezoelectric vibration device comprising:
a frame having an elongated shape;
a first vibration plate supported by the frame and having an elongated shape elongated in a longitudinal direction of the frame; and
a piezoelectric layer arranged on the first vibration plate.

2. The piezoelectric vibration device according to claim 1, wherein the frame includes
a first long side portion,
a second long side portion opposite the first long side portion,
a first short side portion connecting a first end of the first long side portion and a first end of the second long side portion, and
a second short side portion facing the first short side portion and connecting a second end of the first long side portion and a second end of the second long side portion, and
wherein the first vibration plate is supported by at least one of the first short side portion or the second short side portion.

3. The piezoelectric vibration device according to claim 1, further comprising:
a second vibration plate connected to the first vibration plate through a connecting body and configured to vibrate in conjunction with vibration of the first vibration plate.

4. A speaker unit comprising:
a piezoelectric vibration device,
wherein the piezoelectric vibration device includes
a frame having an elongated shape,
a first vibration plate supported by the frame and having an elongated shape elongated in a longitudinal direction of the frame, and
a piezoelectric layer arranged on the first vibration plate.

5. The speaker unit according to claim 4, further comprising:
a housing having an elongated cylindrical shape and accommodating the piezoelectric vibration device,
wherein the housing includes
a first opening, and
a second opening,
wherein the housing includes a first space and a second space that are separated by the piezoelectric vibration device,
wherein the first opening communicates with the first space, and
wherein the second opening communicates with the second space.

6. An earphone comprising
a speaker unit including a piezoelectric vibration device, the piezoelectric vibration device including
a frame having an elongated shape,
a first vibration plate supported by the frame and having an elongated shape elongated in a longitudinal direction of the frame, and
a piezoelectric layer arranged on the first vibration plate.

7. The earphone according to claim 6, wherein the speaker unit includes a housing having an elongated cylindrical shape and accommodating the piezoelectric vibration device,
wherein the housing has a first opening and a second opening,
wherein the housing includes a first space and a second space that are separated by the piezoelectric vibration device,
wherein the first opening communicates with the first space, and
wherein the second opening communicates with the second space.

8. The earphone according to claim 6, wherein the speaker unit includes a housing having an elongated cylindrical shape and accommodating the piezoelectric vibration device, and
wherein a long side portion of the piezoelectric vibration device or a longitudinal direction of the housing is directed in a depth direction of an external auditory canal of an ear of a user.
